(19) United States
(12) Patent Application Publication
(10) Pub. No.: US 2008/0313559 A1
(43) Pub. Date: Dec. 18, 2008

(54) FUNCTIONALITY FOR HANDHELD FIELD MAINTENANCE TOOLS

(76) Inventors: Christian J. Kulus, St. Paul, MN (US); Brad N. Mathiowetz, Lakeville, MN (US)

Correspondence Address: Christopher R. Christenson;WESTMAN, CHAMPLIN & KELLY, P.A., Suite 1400, 900 Second Avenue South, Minneapolis, MN, 55402-3319, US

(21) Appl. No.: 12/138,720

(22) Filed: Jun. 13, 2008

Related U.S. Application Data
(60) Provisional application No. 60/934,348, filed on Jun. 13, 2007.

(51) Int. Cl. G06F 3/048

(52) U.S. Cl. 715/771

(57) ABSTRACT

Improved functionality of handheld field maintenance tools is provided. A user may interact with the handheld field maintenance tool using a software application that communicates with the tool and with a manufacturer server. Tool information, including a unique tool identifier, is uploaded from the tool and associated with at least some user information. The user is able to view additional and/or updated functionality information relative to one or more tools with which the user is associated and obtain additional functionality electronically. The user also is provided with the ability to provide a tool name that is stored and displayed on the tool.

### CROSS-REFERENCE TO RELATED APPLICATION

The present application is based on and claims the benefit of U.S. provisional patent application Ser. No. 60/934,348 filed Jun. 13, 2007, the content of which is hereby incorporated by reference in its entirety.

### BACKGROUND

Handheld field maintenance tools are known. Such tools are highly useful in the process control and measurement industry to allow operators to conveniently communicate with and/or interrogate field devices in a given process installation. Examples of such process installations include petroleum, pharmaceutical, chemical, pulp, and other processing installations. In such installations, the process control and measurement network may include tens or even hundreds of various field devices which periodically require maintenance to ensure that such devices are functioning properly and/or calibrated. Moreover, when one or more errors in the process control and measurement installation is detected, use of a handheld field maintenance tool allows technicians to quickly diagnose such errors in the field.

Examples of commercially available handheld field maintenance tools include the Model 375 Field Communicator available from Fisher-Rosemount Systems, Inc. of Austin, Tex. The Model 375 Field Communicator was recently introduced to replace the previous Model 275 HART® Communicator. The Model 375 Field Communicator user interface is similar to the previous Model 275, but includes support for FOUNDATION™ Fieldbus devices as well as HART®, revision 6 support. The Model 375 Field Communicator is one example of a handheld field maintenance tool that is delivered to users with ample hardware support for a wide array of functionality. In order to manufacture the hardware efficiently, the hardware itself is substantially the same, regardless of the functionality that is ultimately required by the end-user. Further, end-users are provided with the ability to purchase, or otherwise obtain, the handheld field maintenance tool at a reduced cost, by selecting reduced functionality. Accordingly, a given handheld field maintenance tool is generally provided to a customer with a predetermined set of functionality.

In the past, if the manufacturer were to create new functionality or if the customer would like to have additional functionality added to their handheld field maintenance tool, the process of adding, renewing, or updating functionality could be difficult and time-consuming. Further, end-users would not always know the precise functionality that was enabled within their handheld field maintenance tool, or what new, or updated, functionality was available that may have been released by the manufacturer after the handheld field maintenance tool was purchased or otherwise obtained.

One common solution to the problem of adding, or updating functionality to handheld field maintenance tools, often required the end-user to physically send the handheld field maintenance device, itself, to a service location where the functionality would be added by trained technicians. However, this process was troublesome for end-users in that they would temporarily lose the use of their handheld field maintenance tool while it was at the service location. This was also problematic for the service location as the difficulty in upgrading, or otherwise adding new or updated features to the handheld field maintenance tool, would discourage end-users from adding or updating functionality. An additional problem was that the service location would need to be provided, by the manufacturer, with the ability to add licenses. This generally required a specialized utility that could be run by the service location to generate or change license information on handheld field maintenance tools. This special utility's creation and maintenance was a significant expense to manufacturers.

More recently, end-users have been provided with the ability to add desired functionality by ordering a hardware component, such as a memory chip or cartridge that can be integrated with their handheld field maintenance tool. However, since there is still a physical component that needs to ship to the end-user, this solution can often cause a delay to the end-user once they realize their desire for the new functionality. Additionally, the use of the physical component creates a problem of material cost and shipment costs that must be borne by the end-user, the manufacturer, or a combination. Examples of physical components that have been used include a memory chip (such as an EEPROM or SD card) or an external adapter interface such as a dongle.

An additional difficulty encountered by manufacturers to market, or otherwise inform current users (previous purchasers) of new capabilities and/or technical updates for their handheld field maintenance tools has been caused by the way in which handheld field maintenance tools have been distributed. Specifically, the distribution channel of a handheld field maintenance tool is often multi-leveled. Once the handheld field maintenance tool leaves the manufacturer, it can pass through several distribution locations and companies both internal and external to the manufacturer before reaching the end-user. Because of this, it is often impractical to link a specific technician or entity to a purchased or otherwise obtained handheld field maintenance tool, or to even know the exact configuration of the handheld field maintenance tool (e.g., license, hardware, software) that the end-user has received. While solutions such as the completion of a “registration card” would seem to address this limitation, such cards have historically proven to be ineffective, both because customers are unwilling to participate and because information provided may not be sufficiently detailed or may contain errors. Another possible way in which this distribution channel limitation has been addressed is in the collection of data when the handheld field maintenance tool is sold, or otherwise provided to the end-user. While this can be effective, the solution often adds a significant amount of work to each order, increases cost, decreases order efficiency, and can cause delays in shipment. Additionally, in a multi-level distribution channel, the information collected can still be difficult for the manufacturer to obtain. This difficulty may be due to the ultimate point of sale being unwilling or unable to collect the data, or unwilling or unable to provide it back to the manufacturer effectively even if it is collected.

Providing a system and method in which end-users of handheld field maintenance tools could be easily provided with new information, updates, and capabilities relative to their handheld field maintenance tools as well as ways in which such updates and functionality could be obtained would better allow end-users to use specifically-selected functionality in their handheld field maintenance tools.

### SUMMARY

Improved functionality of handheld field maintenance tools is provided. A user may interact with the handheld field maintenance tool using a software application that communicates with the tool and with a manufacturer server. Tool information, including a unique tool identifier, is uploaded from the tool and associated with at least some user information. The user is able to view additional and/or updated functionality information relative to one or more tools with which the user is associated and obtain additional functionality electronically. The user also is provided with the ability to provide a tool name that is stored and displayed on the tool.

### BRIEF DESCRIPTION OF THE DRAWINGS

FIG. 1 is a diagrammatic view of an exemplary system in which embodiments of the present invention are useful.

FIG. 2 is a diagrammatic view of a handheld field maintenance tool with which embodiments of the present invention are particularly useful.

FIG. 3 is a diagrammatic view of a system for interacting with a handheld field maintenance tool in accordance with an embodiment of the present invention.

FIG. 4 is a diagrammatic view of various modules and an application on system in accordance with an embodiment of the present invention.

FIG. 5 is a diagrammatic view of a method of interacting with a handheld field maintenance tool in accordance with an embodiment of the present invention.

FIGS. 6-8 are diagrammatic screenshots illustrating graphical user interfaces generated during the method illustrated in FIG. 5.

FIG. 10 is a diagrammatic view of a method of selecting additional functionality for a handheld field maintenance tool in accordance with an embodiment of the present invention.

FIGS. 11 and 12 are diagrammatic screenshots illustrating graphical user interfaces generated during the method illustrated in FIG. 10.

FIG. 13 is a diagrammatic view of a method of updating license information on a handheld field maintenance tool in accordance with an embodiment of the present invention.

FIGS. 14 and 15 are diagrammatic screenshots.

### DETAILED DESCRIPTION

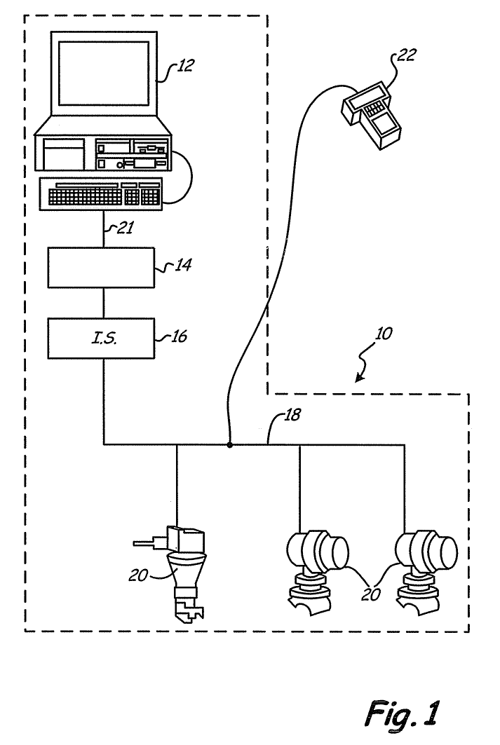

FIG. 1 illustrates an exemplary system in which embodiments of the present invention are useful. System 10 includes controller 12, I/O and control sub-system 14, intrinsic safety (IS) barrier 16, process communication loop 18 and field devices 20. Controller 12 is coupled to I/O and control sub-system 14 via link 21 which can be any suitable link such as a local area network (LAN) operating in accordance with Ethernet signaling protocols or any other suitable protocol. I/O and control sub-system 14 is coupled to intrinsic safety barrier 16 which in turn is coupled to process communication loop 18 to allow data communication between loop 18 and I/O and control sub-system 14 in a manner that limits energy passing therethrough.

In this illustration, process communication or process control loop 18 is a FOUNDATION™ Fieldbus process communication loop and is coupled to field devices 20, which are shown arranged in a multi-drop configuration. An alternative process communication loop (not shown) is an HART® process communication loop. FIG. 1 illustrates a multi-drop wiring configuration that vastly simplifies system wiring compared to other topologies such as the star topology. Multi-drop HART® configurations support a maximum of 15 devices, while multi-drop FOUNDATION™ Fieldbus configurations support a maximum of 32 devices.

Handheld field maintenance tool 22 is coupled to loop 18 as illustrated in FIG. 1. When coupled to a process control loop as shown, tool 22 can perform a number of communication and diagnostic functions.

In some embodiments, tool 22 can comply with intrinsic safety requirements set forth in: APPROVAL STANDARD INTRINSICALLY SAFE APPARATUS AND ASSOCIATED APPARATUS FOR USE IN CLASS I, II AND III, DIVISION 1 HAZARDOUS (CLASSIFIED) LOCATIONS, CLASS NUMBER 3610, promulgated by Factory Mutual Research October, 1988. Adaptations to comply with additional industrial standards such as Canadian Standards Association (CSA) and the European CENELEC standards are also contemplated.

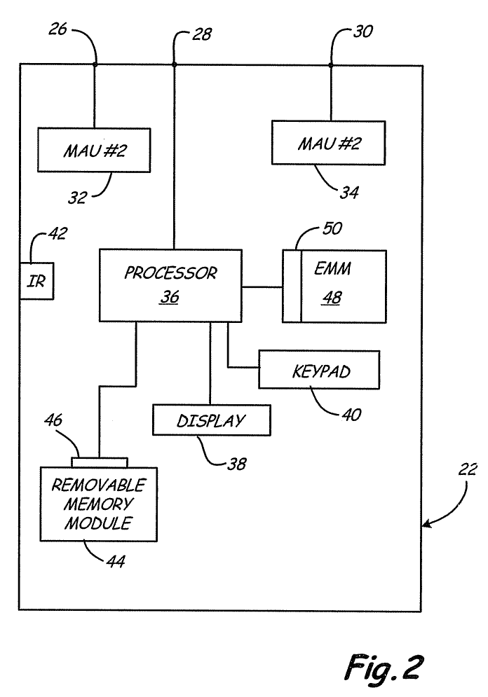

FIG. 2 is a diagrammatic view of handheld field maintenance tool 22 with which embodiments of the present invention are particularly useful. Tool 22 preferably includes three communication terminals 26, 28 and 30 which facilitate coupling tool 22 to process communication loops and/or devices in accordance with at least two process industry standard protocols. For example, when tool 22 is coupled to a loop of a first process industry standard protocol, such coupling is effected using terminal 26 and common terminal 28. Accordingly, the connection then is made via media access unit 32 which is configured to interact upon the process communication loop in accordance with the first industry standard protocol. Additionally, when tool 22 is to be coupled to a process and control measurement loop that operates in accordance with a second industry standard protocol, such connection is made via common terminal 28 and terminal 30. Thus, such a connection is effected via the second media access unit 34 which is configured to interact upon the process communication loop in accordance with the second industry standard protocol. Both media access units 32 and 34 are coupled to processor 36 which receives data from one of the media access units and interprets that data accordingly.

Processor 36 is also coupled to keypad module 38 and display module 40. Keypad module 38 is coupled to the keypad on the housing of tool 22 in order to receive various keypad inputs from a user. Display module 40 is coupled to the display to provide data and/or a user interface to the user.

In this embodiment, tool 22 includes infrared data access (IrDa) port 42 which is coupled to processor 36 to allow tool 22 to transfer information to and receive information from a separate device using infrared wireless communication. One advantageous use of port 42 is for transferring and/or updating Device Descriptions stored in one or more memories of tool 22. A Device Description (DD) is a software technology used to describe parameters in a field device in a computer-readable format. This contains all of the information necessary for a software application being executed on processor 36 to retrieve and use the parametric data. The separate device, such as computer 12, can obtain a new Device Description from floppy disk, CD ROM, or the internet and wirelessly transfer the new Device Description to tool 22.

Removable memory module 44 is removably coupled to processor 36 via port/interface 46. Removable memory module 44 is adapted to store software applications that can be executed instead of primary applications on processor 36. For example, module 44 may contain applications that use the HART® or FOUNDATION™ Fieldbus communication port, to provide a comprehensive diagnostic for a given process valve. Additionally, module 44 may store software applications that aid in the calibration or configuration of specific devices. Module 44 may also contain a software image for a new or updated primary device application that can subsequently be transferred into the non-volatile memory of processor 36 to enable execution of the updated application. Further still, module 44 provides removable memory storage for the configuration of multiple devices allowing a field maintenance operator or technician to acquire a relatively substantial amount of device data and conveniently store or transfer such data by simply removing module 44.

Tool 22 also preferably includes expansion memory module 48 coupled to processor 36 via connector 50. Expansion memory module 48 may contain Device Descriptions of first and second industry standard protocols. Module 48 may also contain license code(s) that will determine the functionality of tool 22 with respect to the multiple protocols. For example, data residing within module 48 may indicate that tool 22 is only authorized to operate within a single process industry standard mode, such as the HART® protocol. Ultimately, a different setting of that data within module 48 may indicate that tool 22 is authorized to operate in accordance with two or more industry standard protocols. Module 48 is preferably inserted to connector 50 on the main board of tool 22 and may in fact require partial disassembly of tool 22, such as removing the battery pack to access port 50.

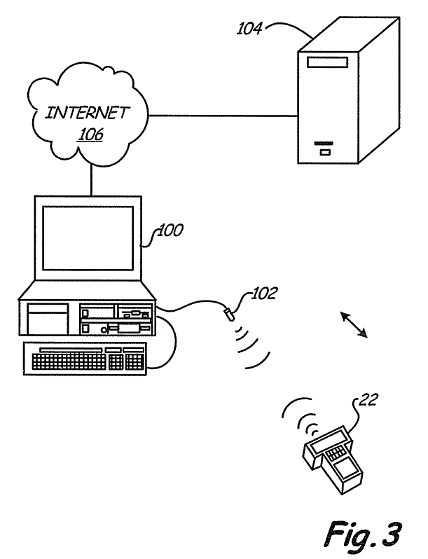

FIG. 3 is a diagrammatic view of a system for interacting with a handheld field maintenance tool in accordance with an embodiment of the present invention. FIG. 3 illustrates computer system 100 interacting with handheld field maintenance tool 22 using wireless, such as infrared, communication. System 100 may be the same physical system as computer 12 (shown in FIG. 1) but need not be, so a different reference numeral is used. System 100 preferably employs a commercially-available infrared port (IrDa) illustrated at reference numeral 102. Some computer systems may have IrDa port 102 disposed as an integral system component, while others may have port 102 as a peripheral device. For example, port 102 may simply connect to system 100 through a serial port such as a USB port, or an RS-232 port. Port 102 of system 100 allows bi-directional wireless communication with tool 22 through IrDa port 42 of tool 22. As will be described in greater detail below, this interaction allows, or otherwise facilitates, a higher level of interaction with tool 22 than was available previously. For example, an application running on system 100 can allow the user to connect to manufacturer server 104 through a suitable connection, such as through internet 106.

Preferably, the communication and interaction between the application running on system 100 and server 104 employs known software technology, such as web services. A web service is defined by the W3C as “a software system designed to support interoperable Machine to Machine interaction over a network.” This simple connection between tool 22 and server 104 provides a much better follow-on experience for the end-user once tool 22 has been purchased, leased, or otherwise obtained.

While FIG. 3 illustrates bi-directional infrared wireless communication between tool 22 and system 100, that is merely the preferred embodiment.

In fact, tool 22 could be operably coupled to system 100 through a wired interface, such as a USB connection, or through a different form of wireless communication, such as Wireless Fidelity (WiFi) in accordance with IEEE 802.11b or IEEE 802.11g, the known Bluetooth standard, or other suitable wireless technologies.

The interaction between tool 22 and server 104 is also preferably through system 100 using a suitable application. However, embodiments of the present invention can be practiced with any suitable communications link to server 104. For example, tool 22 may contain a WiFi module, or communicate in accordance with a cellular data communication standard such as Microburst® by Aeris Communications Inc. of San Jose, Calif., ultra wide band, free space optics, Global System for Mobile Communications (GSM), General Packet Radio Service (GPRS), Code Division Multiple Access (CDMA), spread spectrum technology, SMS (Short Messaging Service/text messaging), or any other suitable wireless technology through internet 106. However, the various embodiments of the present invention will be described hereinafter via interaction with a software application being executed on system 100.

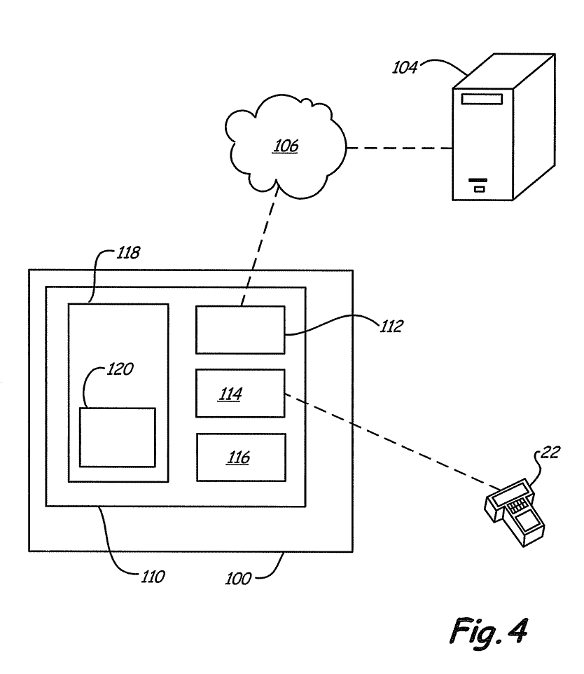

FIG. 4 is a diagrammatic view of various modules and an application running on system 100 in accordance with an embodiment of the present invention. System 100 includes an operating system that can be any suitable operating system such as that available from Microsoft Corporation, of Redmond, Wash., under the trade designation Windows Vista®.

Operating system 110 typically includes a TCP/IP communication stack 112 that interacts with a physical layer such as an Ethernet physical layer or modem to establish a connection to a network, such as internet 106. Operating system 110 will also typically include module 114 to interact with local I/O devices such as a serial port. The serial port provides communication with tool 22 as described above. Finally, operating system 110 will typically include user interface module 116 to allow operating system 110, or applications executing thereon, to render displays upon a display device, such as an LCD screen, to interact with the user.

Application 118 runs on system 100, which can be any general purpose personal computer or suitable mobile device, using operating system 110. Application 118 can be used to provide one or more computer-implemented methods in accordance with various embodiments of the present invention. Application 118 preferably interacts with modules 112, 114 and 116 through application programming interfaces (APIs) of operating system 110. Application 118 preferably includes a local data store 120 that can be embodied in any suitable form, but is preferably a relational database.

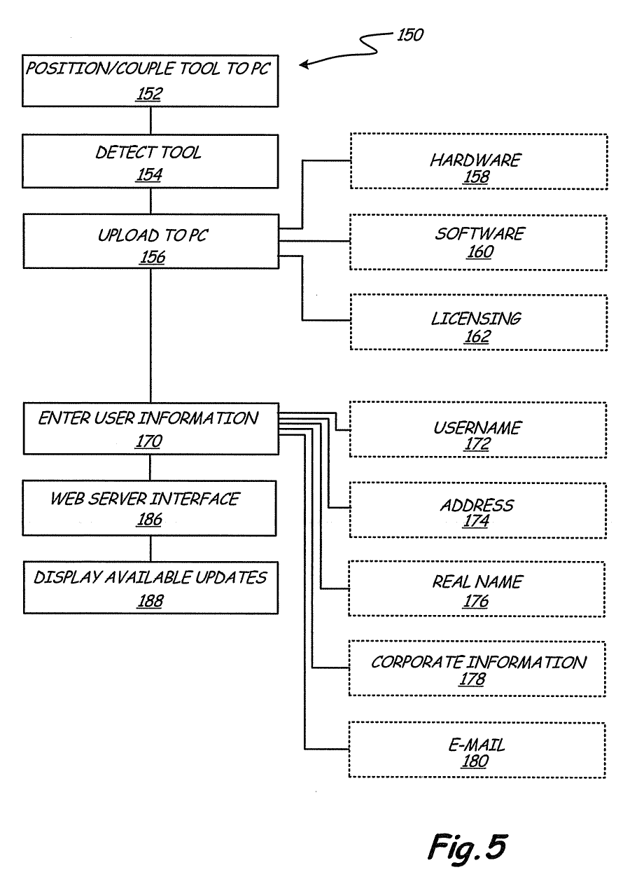

FIG. 5 is a diagrammatic view of a method of interacting with a handheld field maintenance tool in accordance with an embodiment of the present invention. Method 150 begins at block 152 where a user positions or otherwise couples a tool, such as tool 22, to computer system 100. In a preferred embodiment, block 152 includes simply orienting the IrDa port 42 of tool 22 to be communicatively coupled with port 102 of system 100. However, other arrangements, such as simply providing a wired connection between the tool 22 and system 100 is contemplated by block 152. Next, at block 154, method 150 attempts to detect tool 22 by communicating with it through the connection generated at block 152. Thus, in embodiments where tool 22 interacts with system 100 through its infrared port 42, block 154 will cause system 100 to generate a signal, or series of infrared pulses through port 102 to attempt to communicate with, or otherwise detect tool 22. If method 150, at block 154, determines that the tool cannot be detected, a suitable error is provided to the user through display module 116. If, however, tool 22 is detected by system 100, then method 150 passes to block 156 where information stored on the handheld field maintenance tool is uploaded to system 100.

Suitable examples of information that can be uploaded from tool 22 to system 100 include hardware information 158, software information 160, and licensing information 162. Hardware information 158 includes any suitable information regarding the electronic components that comprise handheld field maintenance tool 22. Examples of such information include specific manufacturer part numbers of specific integrated circuits; such as the microprocessor of tool 22; the type of memory, both volatile and non-volatile, used by handheld field maintenance tool 22; build dates and codes with respect to both individual components of handheld field maintenance tool 22 and those of tool 22 itself. Further, hardware information 158 can also include dynamic information about the hardware, such as diagnostic information relative to handheld field maintenance tool 22. Such diagnostic or dynamic information can include current temperature of critical system components; the amount of volatile and/or nonvolatile free memory remaining; any current trouble codes; and any salient log information indicating past hardware malfunction. Hardware information 158 also includes one or more indicators that uniquely identify tool 22 among all handheld field maintenance tools manufactured by the manufacturer. One example is the unique serial number stored within the hardware itself, or on a non-changeable area within memory of tool 22.

Software information 160 includes any suitable information relative to any software (including the operating system) of handheld field maintenance tool 22 stored or executed by handheld field maintenance tool 22. Examples of software information preferably include a description of the software; the version of the software; dates and times when changes have been made to the software, such as an update; and software diagnostic information, such as current error codes or a log of past errors experienced by any of the software executing upon tool 22. Further, software information 160 can include information about stored device descriptions or any other suitable data.

Licensing information 162 can include specific information about functionality of a software module, hardware module, or combination thereof. Further, license information 162 may include information that is able to allow tool 22 to selectively enable only a portion of functionality that is otherwise fully enabled by the mere presence of suitable hardware and software on tool 22. Further still, license information 162 can include an expiration date upon which currently-licensed software may expire.

Preferably, the upload of information from tool 22 to system 100 occurs every time an interface is made between tool 22 and system 100. Certainly, the occurrence of this upload is preferred as part of a registration of tool 22 subsequent to the initial acquisition of tool 22 by the end-user, and as part of any separate activity, such as the end-user wishing to purchase additional functionality. Moreover, since all of this detailed information is uploaded to system 100 without extensive interaction by the user, it is believed that the user's experience will be improved.

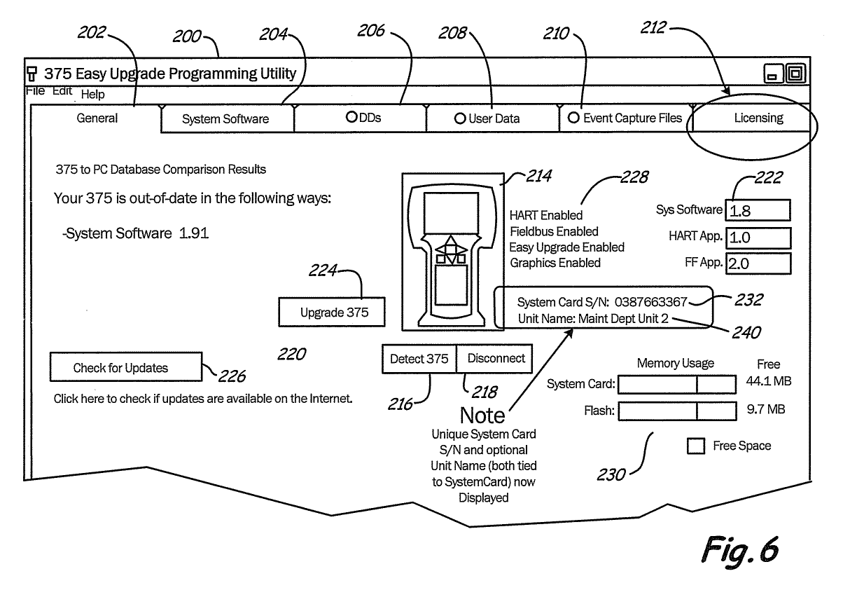

Preferably, once block 156 is executed, and system 100 has significant hardware, software, and licensing information relative to the connected tool 22, system 100 displays a user interface to the user through module 116. One exemplary user interface is illustrated in FIG. 6. User interface 200 is preferably tabbed, having General tab 202, System Software tab 204, Device Description tab 206, User Data tab 208, Event Capture File tab 210, and Licensing tab 212. FIG. 6 illustrates General tab 202 selected with a number of general information parameters displayed relative to a connected handheld field maintenance tool.

Interface 200 includes a computer-generated representation of the connected tool 22 in window 214. Additionally, tool 200 includes buttons or other suitable interface elements 216, 218 to detect and disconnect tool 22, respectively. As illustrated in FIG. 6, button 216 is grayed or otherwise de-emphasized because tool 22 has been successfully detected. Preferably, system 100 compares the various software, hardware, and licensing information received from tool 22 to information stored locally in data store 120. This comparison results in an indication, given within window 220 of the ways in which the connected tool 22 is out-of-date or otherwise requires attention. Specifically, in the example given in FIG. 6, system software on the connected tool 22 is out-of-date in that the system software revision number communicated by tool 22 is version 1.8, illustrated in window 222, while the current system software is revision number 1.91. User interface 200 includes a simple and intuitive control 224, illustrated as a button, which easily allows the user to upgrade or otherwise update any out-of-date aspects of their tool 22. Additionally, user interface element 226 is also preferably provided which allows the user to communicate with the manufacturer server 104 through TCP/IP stack 112 and internet 106. FIG. 6 also illustrates a number of aspects of the connected tool 22 being displayed to the user. Specifically, various modules are indicated as enabled or disabled at reference numeral 228. Further, memory usage, both with respect to the system card and the flash memory, is illustrated at reference numeral 230. The system card serial number is illustrated at 232.

FIG. 6 also illustrates that tool 22 has been given a user-provided unit name 240 as “Maint Dept Unit 2.” Interface 200 is simply one suitable interface, such as that embodied upon system 100, that allows a user to create a personalized name for handheld field maintenance tool 22 and then have the name saved somewhere within the memory of handheld 22. Additionally, the interface can be provided by tool 22 itself. Preferably, however, interface 200 is provided as part of the programming utility supplied with the handheld tool 22. When a tool is connected to application 118, otherwise referred to herein as a programming utility, a field, or box, becomes available that allows the user to save a name for the handheld field maintenance tool. The name provided by the user is preferably saved in the license file on the system card, which means that if the system card were to be moved to another handheld field maintenance tool, the user-assigned name would move with the system card. Alternatively, the user-supplied name can be stored in unit flash memory. It is preferred that the name be tied to an item that also controls licensing within the unit, which is preferably the system card. Once the name has been stored within the handheld field maintenance tool, application 118 can display unit name 240 whenever interacting with tool 22. In addition, application 118 can collect archive data about tool 22 and display its unit name as part of the archive. In doing this, the end-user can view an archive of multiple handheld field maintenance units and easily differentiate between them. Further, it is also preferred that the user interface of tool 22 display its user-supplied name. This can be performed immediately when tool 22 initially starts up, so that the user does not have to wait too long to determine which specific tool they are using.

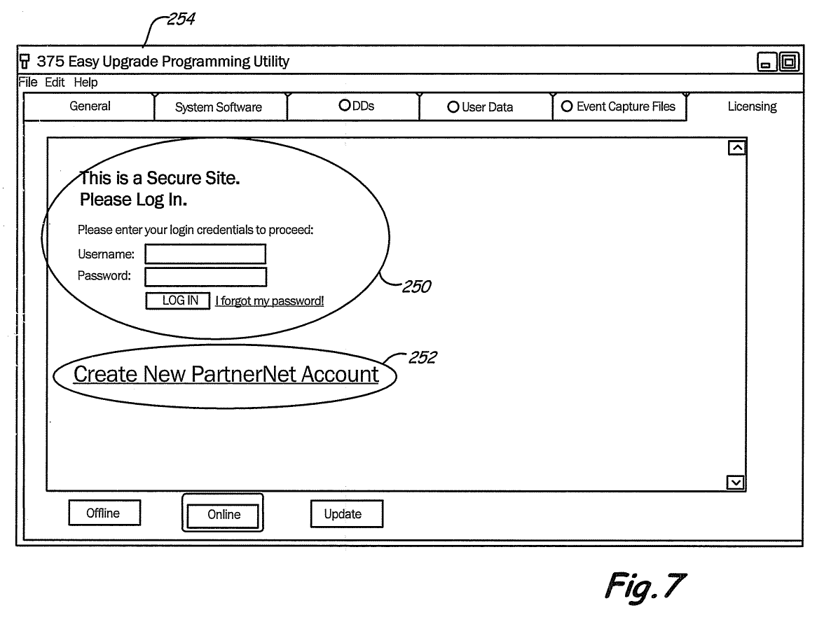

Referring back to FIG. 5, after block 156 executes, and uploaded information is displayed on user interface 200, method 150 continues by allowing the user to enter user information at block 170. Typically, use of a simple login portal such as that displayed in FIG. 7 is all that would be necessary to obtain user information that can be linked, or otherwise coupled, with tool information uploaded to system 100 in block 156. Accordingly, the login information would require user name 172. However, it is also preferred that method 150 obtain further information regarding the user. Such further information can include the address 174 of the user; the real name 176 of the user; corporate information 178 relative to the user; and preferably an email address 180 of the user. As illustrated in FIG. 7, the user name would be received from the user each and every time the user would login to login area 250. However, if the user has not yet created an on-line account, such as the illustrated “PartnerNet” account, the user can select “Create New PartnerNet Account” at reference numeral 252. The creation of the new PartnerNet account can then obtain the various address 174; real name 176; corporation information 178; and email information 180 as desired. Moreover, any other suitable information relative to the user or the corporate environment of the user can be obtained at block 170, as desired.

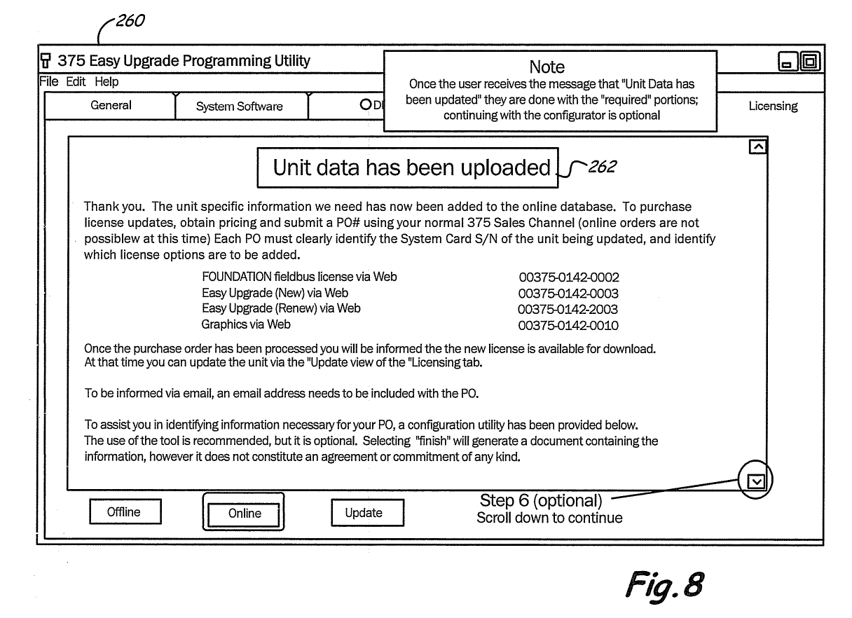

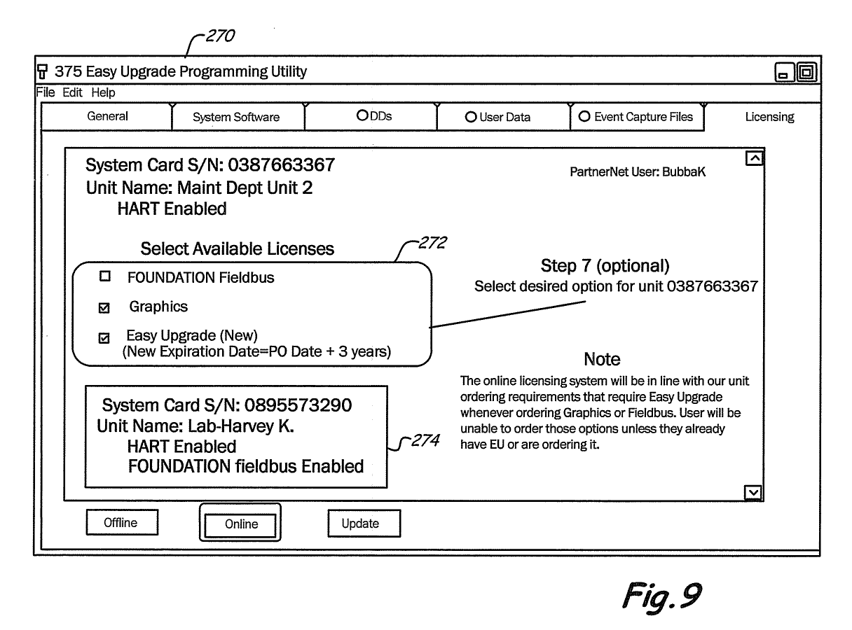

Once the user has submitted user name 172 to user interface 254, method 150 continues at block 186 where application 118 communicates with manufacturer server 104. Preferably, block 186 will cause application 118 to display user interface 260 as illustrated in FIG. 8. Specifically, once application 118 achieves the connection with server 104, all information stored in information store 120 of application 118 with respect to tool 22 is uploaded to server 104. Server 104 then causes application 118 to provide an indication 262 to the user that requisite unit-specific information has been added to the online database. Server 104 then compares the uploaded unit information from application 118 to a list of all available updates relative to tool 22 and causes application 118 to display user interface 270 providing a listing of available licenses, or updates, in block 272 and as illustrated in FIG. 5 at block 188. The user is then able to select one or more of the available licenses to be acquired for the connected handheld field maintenance tool 22. Additionally, as illustrated in FIG. 9, user interface 270 preferably shows the system card serial number and the unit name of the connected handheld field maintenance tool. Further, it is also preferred that information relative to any other handheld field maintenance tools to which the user is associated be displayed in interface 270. Specifically, information for a non-coupled tool is displayed in block 274. Accordingly, the user of interface 270 is able to purchase, or otherwise obtain, updates or new functionality relative to any handheld field maintenance tool to which the user is associated.

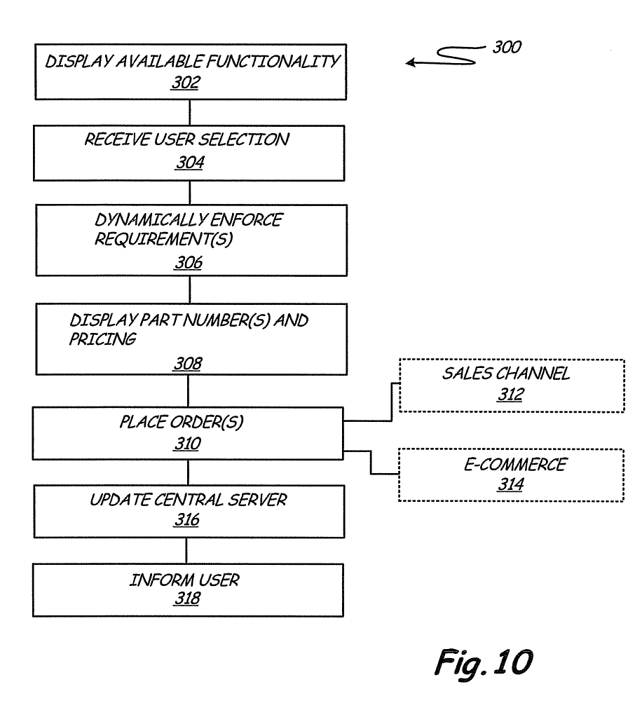

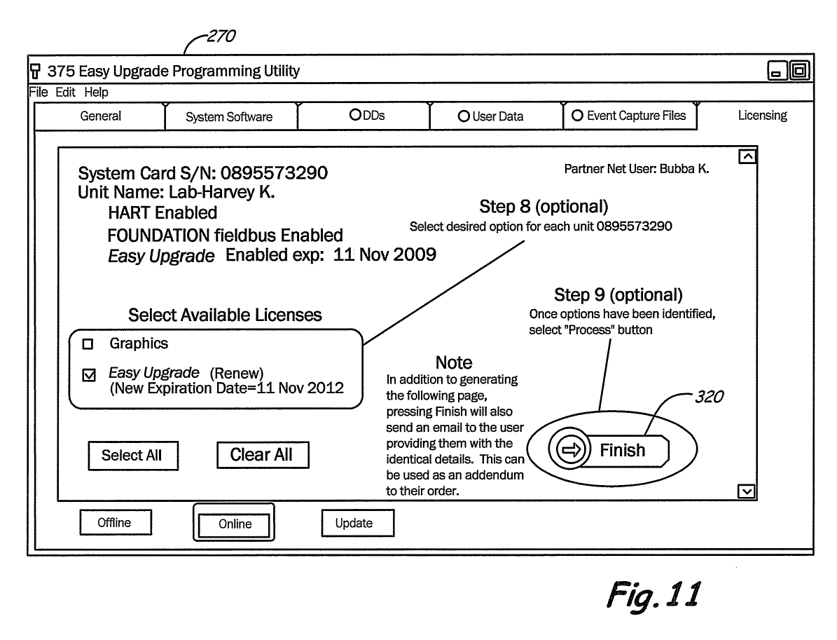

FIG. 10 is a diagrammatic view of a method of selecting additional functionality for a handheld field maintenance tool in accordance with an embodiment of the present invention. Method 300 begins at block 302 where a user is presented with a user interface, such as user interface 270 (shown in FIG. 9) that illustrates available licenses, or additional functionality for one or more handheld field maintenance tools to which the user is associated. For example, FIG. 11 also shows user interface 270 illustrating available licenses for the handheld field maintenance tool illustrated in block 274 in FIG. 9. The user then selects one or more available licenses for one or more handheld field maintenance tools to which the user is associated, illustrated as checkboxes in FIGS. 9 and 11. Specifically, the user has selected a “Graphics” license; an “Easy Upgrade (New)” license with respect to system card serial number 0387663367; and a license for “Easy Upgrade (Renew)” with respect to system card serial number 03895573290. The step of receiving the user selection is illustrated in FIG. 10 at block 304 after which the user indicates that he/she is finished with selections by pressing button 320 in FIG. 11. Once the user has finished selecting available licenses, method 300 continues at block 306 where various requirements for selected licenses are enforced. For example, there could be a requirement that if the user selects item A, they must also select item C. Or, if the user selects item B, item D may no longer be available to the user. Once the various requirements have been dynamically enforced at block 206, method 300 continues at block 308 where part number and price information is displayed to the user for the selected license(s).

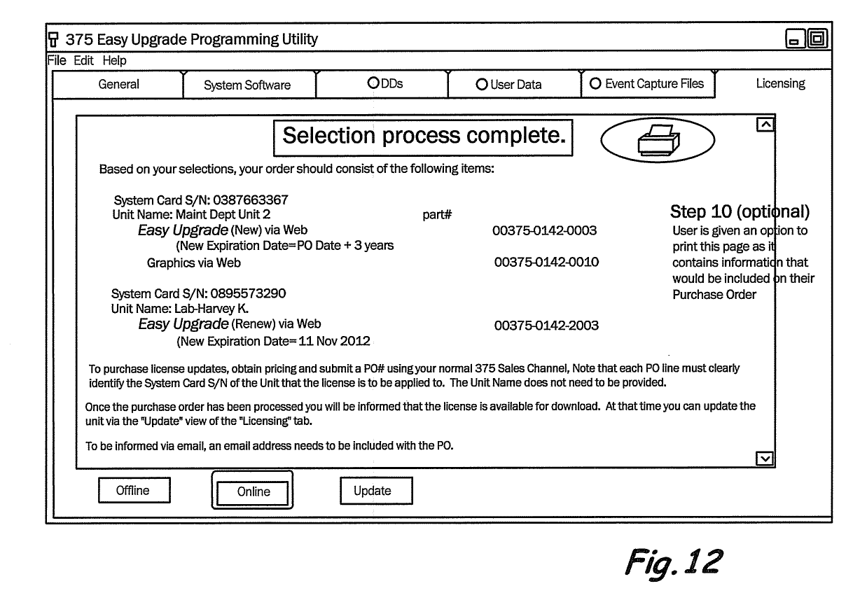

An exemplary user interface display is shown in FIG. 12 as interface 350. The actual placing of the order is illustrated diagrammatically in FIG. 10 at reference numeral 310 and can be effected through standard distribution channels 312, or using known e-commerce technology 314. If standard distribution channels 312 are employed, the user contact a field representative and provides the pricing and P.O. information obtained from interface 350 to have the purchase entered on the user's behalf. Once the purchase order is processed by the manufacturer, central server 104 is updated to include any new licenses that have been ordered, as illustrated at block 316. Once server 104 has been updated, the user is informed via a suitable communication, such as using an email or through application 118 itself that licenses are available for a specific tool 22.

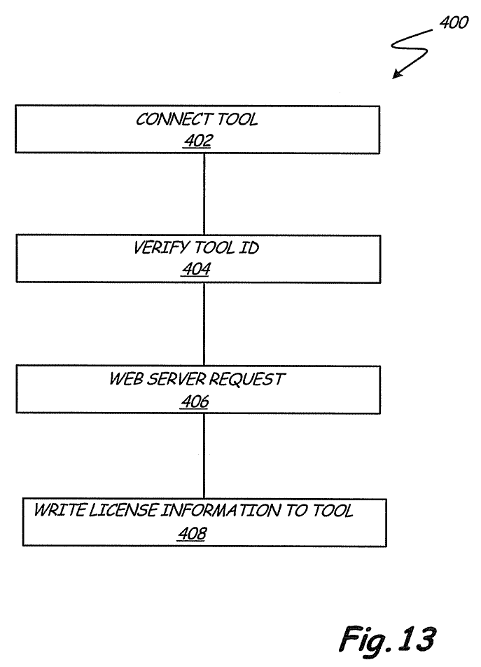

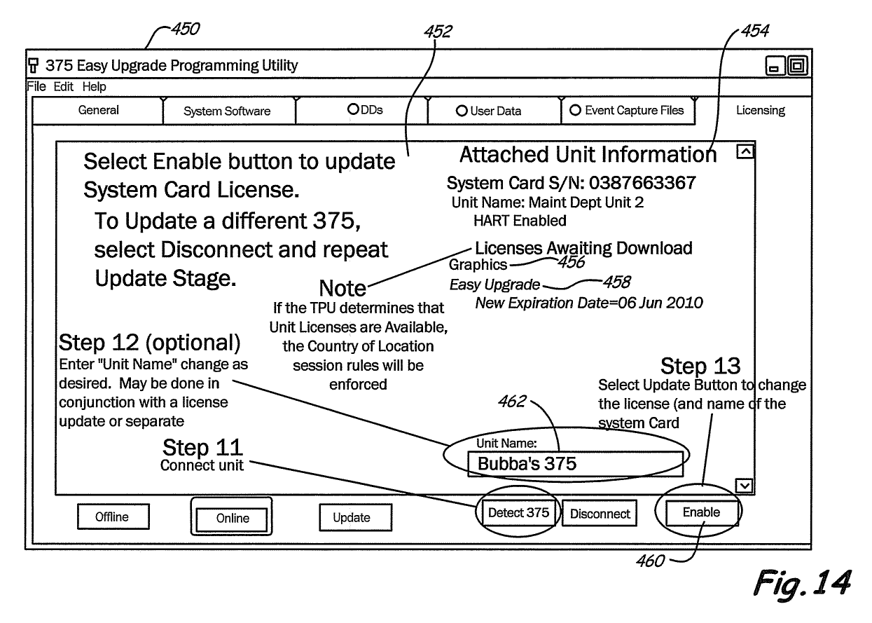

FIG. 13 is a diagrammatic view of a method of updating license information on a handheld field maintenance tool in accordance with an embodiment of the present invention. Method 400 begins at block 402 where a user couples a handheld field maintenance tool to application 118 running on system 100. As set forth above, the user is preferably prompted to such activity by receiving a notification that the manufacturer's server 104 has been updated with new license information relative to a purchase by the user of added or upgraded functionality with respect to the handheld field maintenance tool 22. Once the user has connected or otherwise coupled the tool 22 to application 118, application 118 will verify the unique identifier, such as the system card serial number of the handheld field maintenance tool with which it is communicating. This is illustrated at block 404. Application 118 then makes a request to the manufacturer server 104, as illustrated at block 406, to have server 104 indicate the new functionality that is to made available. Server 104 responds with information that application 188 displays to the user in the form of a user interface as illustrated in FIG. 14, at reference numeral 450. As illustrated in FIG. 14, user interface 450 includes an instructions region 452 that provides instructions to the user such as “Select Enable button to update System Card License” as well as an attached unit information region 454. In region 454, there are two licenses awaiting download: “Graphics” license 456 and “Easy Upgrade” license 458. Next, the user will select the enable button 460 and the new license information is updated by application 118 within the system card, as illustrated at block 408 in FIG. 13.

Note FIG. 14 illustrates field 462 that displaying the unit name. In this case, the user is able to enter text or other suitable alphanumeric data to change the name of the unit. This is simply one example of an interface that allows the user to name, or re-name tool 22.

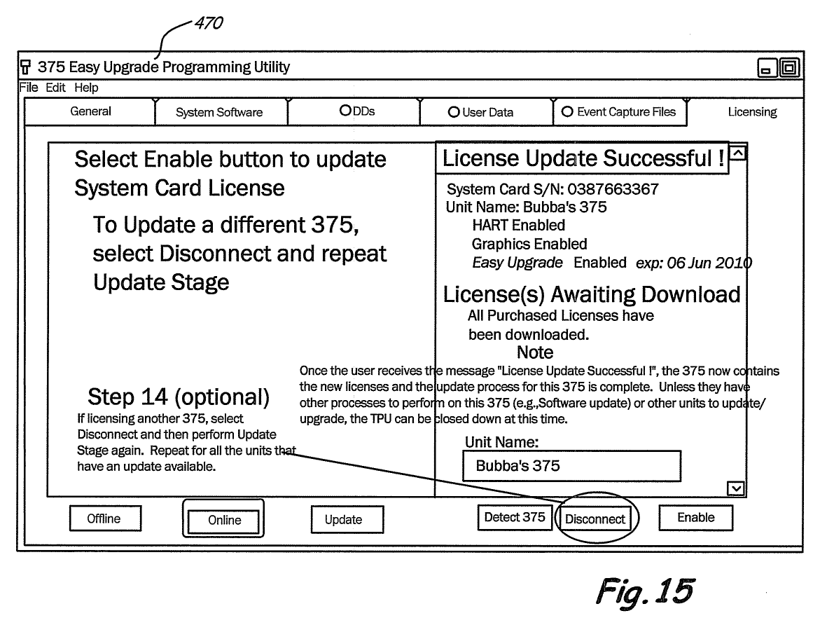

Once the user has selected button 460, application 118 will download the new license information from manufacturer server 104 and write the license information to the memory of tool 22. Once the new license information has been written to tool 22, application 118 can display user interface 470 (shown in FIG. 15) to let the user know whether the license update was successful. The user now has the new or expanded licenses/features available for immediate use in the connected handheld field maintenance tool 22.

Although the present invention has been described with reference to preferred embodiments, workers skilled in the art will recognize that changes may be made in form and detail without departing from the spirit and scope of the invention.

What is claimed is:

1. A method of expanding functionality of a handheld field maintenance tool, the method comprising:
coupling the tool for communication;
uploading tool information from the tool through the communication coupling;
comparing the tool information to currently available functionality information stored in a database; and
displaying available additional functionality to a user based upon the comparison.

2. The method of claim 1, wherein the currently available additional functionality is stored in a database of a computer to which the tool is coupled.

3. The method of claim 1, wherein coupling the tool for communication includes orienting an infrared communication port of the tool with an infrared communication port of a computer system.

4. The method of claim 1, wherein the tool information includes a unique identifier that is unique to the tool among all tools.

5. The method of claim 4, wherein the unique identifier is stored in a system card of the tool.

6. The method of claim 1, wherein the tool is intrinsically safe.

7. The method of claim 1, and further comprising receiving a user selection relative to available additional functionality.

8. The method of claim 7, wherein the user selection is used to provide a display to the user relative to a manufacturer part number and pricing of the selected additional functionality.

9. The method of claim 8, wherein an order is placed to the manufacturer using the part number and pricing.

10. The method of claim 9, wherein the order is placed using electronic commerce.

11. The method of claim 9, wherein a server is updated based upon the order, and a notification is sent to the user.

12. The method of claim 11, wherein the additional functionality is downloaded to the tool after reception of the notification.

13. A method of capturing information relative to a handheld field maintenance tool, the method comprising:
coupling the tool for communication;
uploading tool information from the tool through the communication coupling;
obtaining user information; and
storing the uploaded tool information, the user information and an association between the tool information and the user information.

14. The method of claim 13, wherein the uploaded tool information and the user information is stored in a database of a computer system with which the tool communicates.

15. The method of claim 13, wherein the uploaded tool information and the user information is stored in a database of a manufacturer server.

16. The method of claim 13, wherein the tool is intrinsically safe.

17. The method of claim 13, wherein the tool information includes hardware information.

18. The method of claim 13, wherein the tool information includes software information.

19. The method of claim 13, wherein the tool information includes license information.

20. The method of claim 19, wherein the tool information includes hardware information and software information.

21. The method of claim 13, wherein the user information includes at least a username.

22. A method of assigning a user-provide name to a handheld field maintenance tool, the method comprising:
providing an interface to a user;
receiving a unit name in the form of alphanumeric text from the user; and
storing the unit name in the tool.

23. The method of claim 22, and further comprising displaying the user-assigned unit name on the tool.

24. The method of claim 22, wherein the interface is provided by the tool.

25. The method of claim 22, wherein the interface is provided on a display of a computer system that is communicatively coupled to the tool.

26. The method of claim 22, wherein storing the unit name includes storing the unit name in a license file on a system card of the tool.

27. The method of claim 22, wherein the tool is intrinsically safe.
